(19) United States
(12) Patent Application Publication
(10) Pub. No.: US 2017/0360188 A1
(43) Pub. Date: Dec. 21, 2017

(54) MULTI-FUNCTION DINING TABLE

(71) Applicant: H.T.K. Design, LLC, High Point, NC (US)

(72) Inventor: Seth D. Alguire, High Point, NC (US)

(73) Assignee: H.T.K. Design, LLC, High Point, NC (US)

(21) Appl. No.: 15/464,804

(22) Filed: Mar. 21, 2017

Related U.S. Application Data
(60) Provisional application No. 62/352,342, filed on Jun. 20, 2016.

(51) Int. Cl. A47B 9/00; A47B 33/00; A47B 13/02; A47B 1/04; A47B 21/06; B60B 33/00; A47B 83/04

(52) U.S. Cl. CPC A47B 9/00; B60B 33/00; A47B 33/00; A47B 83/045; A47B 1/04; A47B 21/06; A47B 13/02; A47B 2021/066

(57) ABSTRACT

A multi-function dining table. The dining table includes a tabletop supported by at least two pedestals, the tabletop being configured to be adjustable in a height direction relative to a floor such that the tabletop can be positioned at a sitting height, a counter height, and a standing height. The at least two pedestals are spaced and arranged to accept at least one storage cabinet under the tabletop and between the at least two pedestals.

### FIELD OF THE DISCLOSURE

The present disclosure relates to furniture, and particularly to tables.

### BACKGROUND

Homes are made more inviting and comfortable when well furnished. Well-designed and well-arranged furnishings allow the owner and their guests to most comfortably and effectively interact with their surroundings. The approach to furnishing a home, however, is changing. For example, dining rooms, once set aside as a showpiece of the home, reserved for formal dinner parties and holiday gatherings, have lost favor. Many newly constructed homes simply do not have a space designated as a formal dining room. Owners of more traditional homes that do have a formal “dining room” are less and less likely to be willing to have that space sit ideal for most of the year. Even if formal dining rooms are the primary location for meals, when eat-in kitchens are not present, for example, the formal dining room, and particular the dining table, serves additional functions as well.

Furniture designers continue their efforts to create products that will excite the purchaser with both function and appearance.

### SUMMARY

Embodiments of the present disclosure include a multi-function dining table comprising at least one pedestal and a tabletop supported by the at least one pedestal. The tabletop is configured to be adjustable in a height direction relative to a floor such that the tabletop can be positioned at a sitting height, a counter height, and a standing height. The tabletop comprises at least one leaf capable of extending a support surface of the tabletop. The tabletop comprises integrated controls to actuate at least the height adjustment of the tabletop.

Other embodiments of the present disclosure include a multi-function dining table comprising a tabletop configured to be adjustable in a height direction relative to a floor such that the tabletop can be positioned at a sitting height, a counter height, and a standing height. The dining table further comprises a pair of pedestals supporting the tabletop, and at least one storage cabinet. The at least one storage cabinet comprises at least one drawer and a plurality of casters. The at least one storage cabinet is configured to be stowed below the tabletop and between the pair of pedestals such that the at least one storage cabinet substantially fills a gap between the pair of pedestals such that the tabletop appears to be supported by a single central pedestal at least when positioned at the sitting height.

Further embodiments of the present disclosure include a multi-function dining table comprising a tabletop configured to be adjustable in a height direction relative to a floor such that the tabletop can be positioned at a sitting height, a counter height, and a standing height. The dining table further comprises a pair of pedestals supporting the tabletop, and at least one storage cabinet. The at least one storage cabinet comprises at least one drawer and a plurality of casters. The at least one storage cabinet is configured to be stowed below the tabletop and between the pair of pedestals such that the at least one storage cabinet substantially fills a gap between the pair of pedestals such that the tabletop appears to be supported by a single central pedestal at least when positioned at the sitting height. The tabletop also comprises a pair of leaves disposed below respective opposite ends of the tabletop in a non-extended position, capable of extending a support surface of the tabletop. The tabletop further comprises integrated controls to actuate at least the height adjustment of the tabletop.

These and other aspects of the present invention will become apparent to those skilled in the art after a reading of the following description of the preferred embodiments, when considered in conjunction with the drawings. It should be understood that both the foregoing general description and the following detailed description are explanatory only and are not restrictive of the invention as claimed.

### BRIEF DESCRIPTION OF DRAWINGS

FIG. 1 shows a multi-function dining table according to embodiments of the present disclosure.

FIG. 1A shows the multi-function dining table with a pair of stowable storage cabinets pulled away.

FIG. 2 shows the multi-function dining table according to embodiments of the present disclosure in a formal dining configuration.

FIG. 3 shows the multi-function dining table according to embodiments of the present disclosure in the formal dining configuration with some chairs omitted.

FIG. 4 shows the multi-function dining table according to embodiments of the present disclosure in a first configuration with all chairs omitted.

FIG. 5 shows the multi-function dining table according to embodiments of the present disclosure in a desk configuration.

FIG. 6 shows the multi-function dining table according to embodiments of the present disclosure in a first raised position.

FIG. 7 shows the multi-function dining table according to embodiments of the present disclosure in the first raised position with extension leaves partially unfolded.

FIG. 8 shows the multi-function dining table according to embodiments of the present disclosure in the first raised position with the extension leaves fully unfolded.

FIG. 9 shows the multi-function dining table according to embodiments of the present disclosure in a counter-height position.

FIG. 10 shows the multi-function dining table according to embodiments of the present disclosure in a standing height position.

### DETAILED DESCRIPTION

Exemplary embodiments of this disclosure are described below and illustrated in the accompanying figures, in which like numerals refer to like parts throughout the several views. The embodiments described provide examples and should not be interpreted as limiting the scope of the invention. Other embodiments, and modifications and improvements of the described embodiments, will occur to those skilled in the art and all such other embodiments, modifications and improvements are within the scope of the present invention. Features from one embodiment or aspect may be combined with features from any other embodiment or aspect in any appropriate combination. For example, any individual or collective features of method aspects or embodiments may be applied to apparatus, product or component aspects or embodiments and vice versa.

Applicants have found that in addition to their formal use as a dining room, the next most common use of a dining room is for a home office, due to the availability of a large workspace provided by the tabletop of traditional dining tables. Similarly, both eating and working are not restricted to requiring a low, seated height. Users may wish to eat or work from a standing position, making use of a support surface similar to a counter-top or even a bar.

In view of the increasingly dual functions of a “dining room,” applicants have developed a multi-function dining table that, among other things, is configured to serve as a dining table, a work space or desk, and a stand- or sit-around bar. According to embodiments of the present disclosure, the multi-function dining table described herein may include one, some, or all of the following functional attributes, including: a height adjustable tabletop, an extensible tabletop, tabletop integrated drawer(s), tabletop integrated controls, and stowable storage cabinets.

Referring to the figures collectively, the present disclosure relates to a dining table 100. As used herein, the term “dining table” refers to a piece of furniture having a tabletop 102 comprising at least a main support surface 104 that is sized at least about 72 inches by at least about 42 inches in a non-extended position. Dining tables 100 of the present disclosure are elongated, or non-circular, to result in having a major axis M along a relatively long dimension of the tabletop 102 and a minor axis m along a relatively short dimension of the tabletop. In most embodiments, the dining table 100 is substantially symmetrical about the minor axis m and the major axis M.

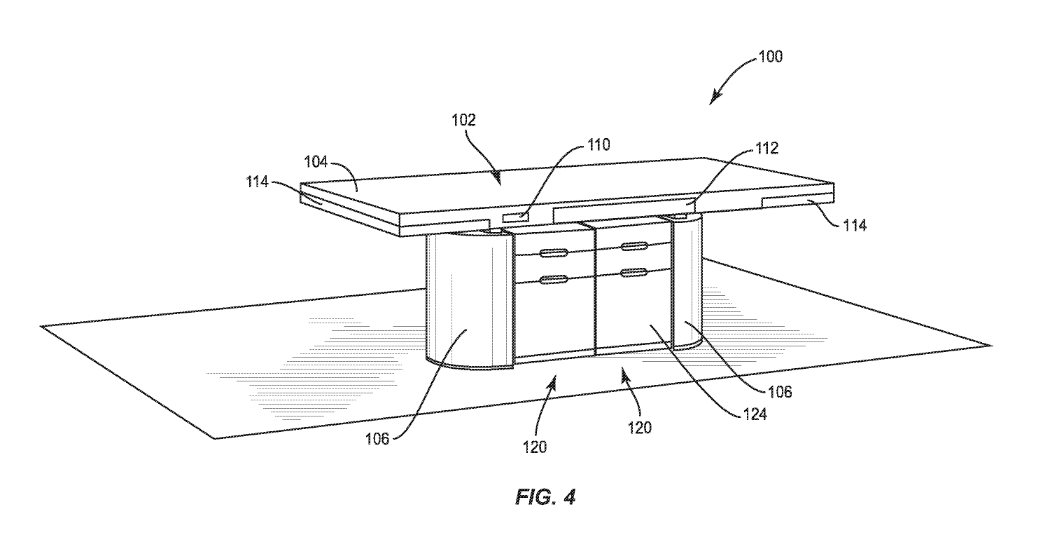

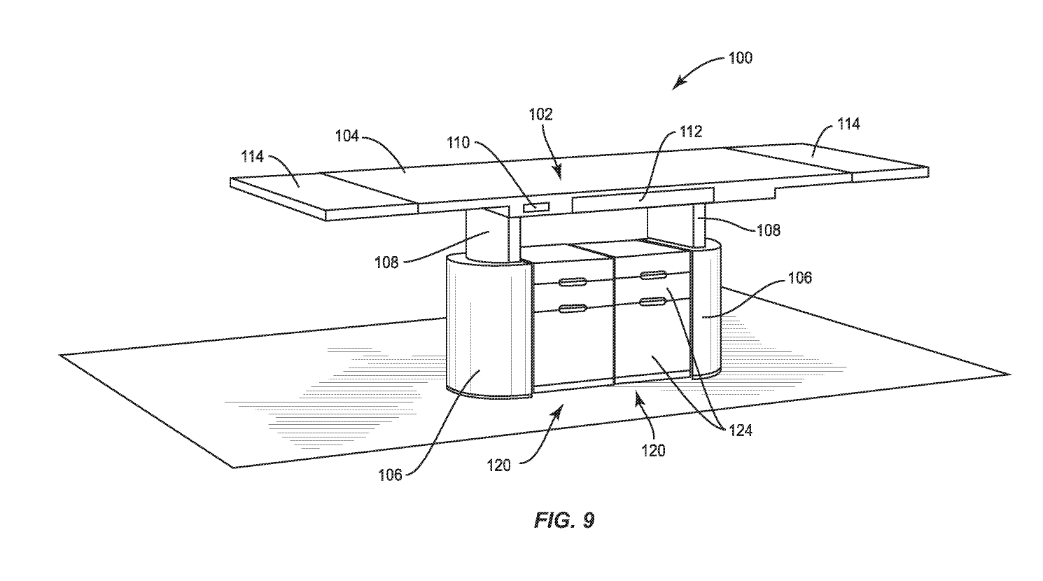

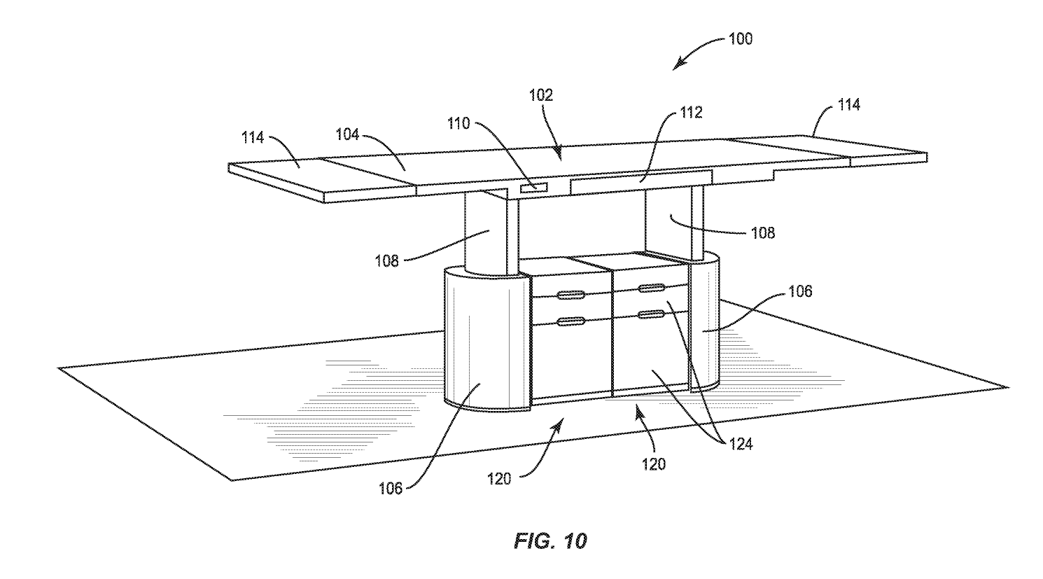

The tabletop 102 is supported at least in part by one or more pedestals 106, preferably a pair of pedestals. One or more of the pedestals 106 can include a manually, mechanically, hydraulically, or electrically driven telescoping portion 108 (see FIG. 10), such as, for example, the TLEL1/SA-94 available from Doug Mockett & Company, Inc. of Manhattan Beach, Calif. The telescoping portion 108 provides a power lift mechanism that allows the support surface 104 to be adjusted in a height direction relative to the floor, and positioned at a substantially infinite number of heights between about 27 inches above the floor to about 45 inches above the floor. The tabletop 102, therefore, provides at least a first height between about 27 and about 30 inches from the floor, referred to as a sitting height (see FIG. 4), a second height about 36 inches from the floor, referred to as a counter height (see FIG. 9), and a third height at least 42 inches above the floor, referred to as a standing or bar height (see FIG. 10). Many other lift mechanisms could suffice.

The telescoping portions 108 may be powered, and controlled by a control panel 110 connected to or otherwise integrated with the tabletop 102 to travel with the tabletop as it translates up and down. In an embodiment, the control panel 110 is a touch panel. In another embodiment, the control panel 110 uses capacitive sensing so that the tabletop 102 can be adjusted without physically contacting the control panel. To maintain the aesthetic of the dining table 100, the control panel 110 should be positioned or designed to be inconspicuous. In an embodiment, the control panel 110 is programmable to allow movement of the tabletop 102 to the seating, counter or standing heights automatically with the press of one or more buttons. In other embodiments, the telescoping portions 108 may be mechanically linked to the tabletop 102 and activated by a manual hand crank.

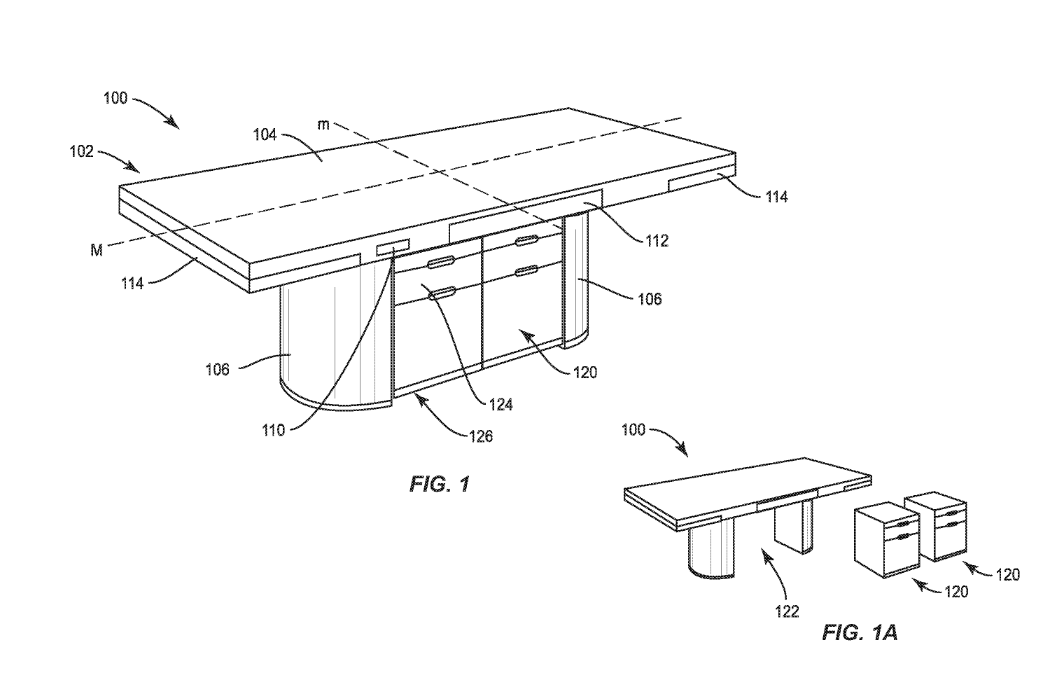

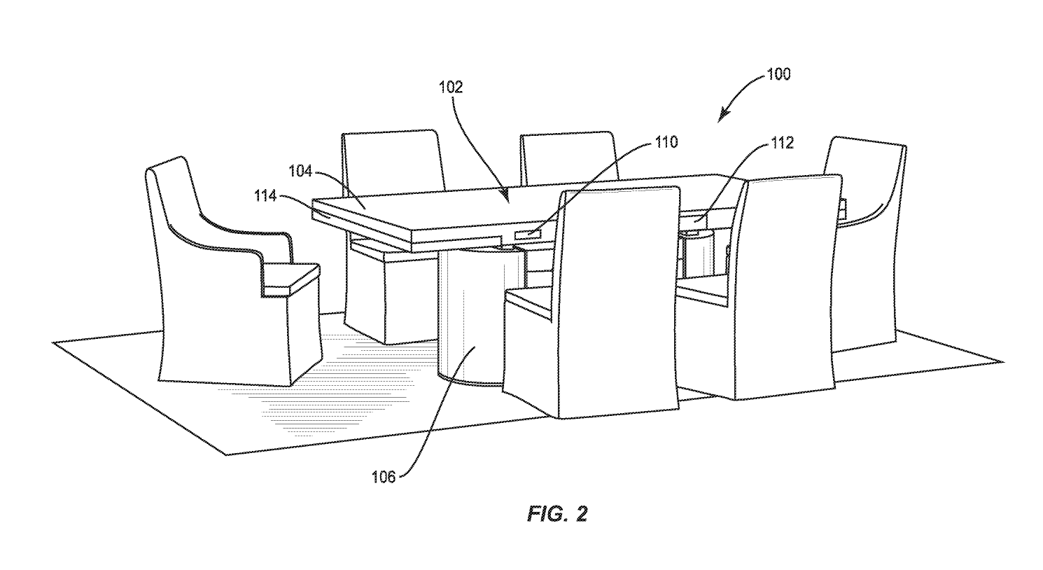

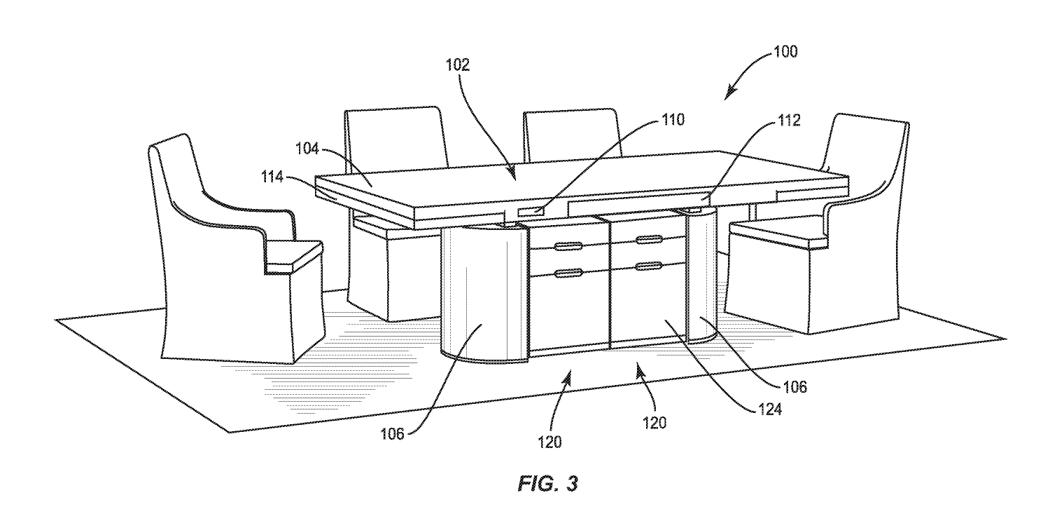

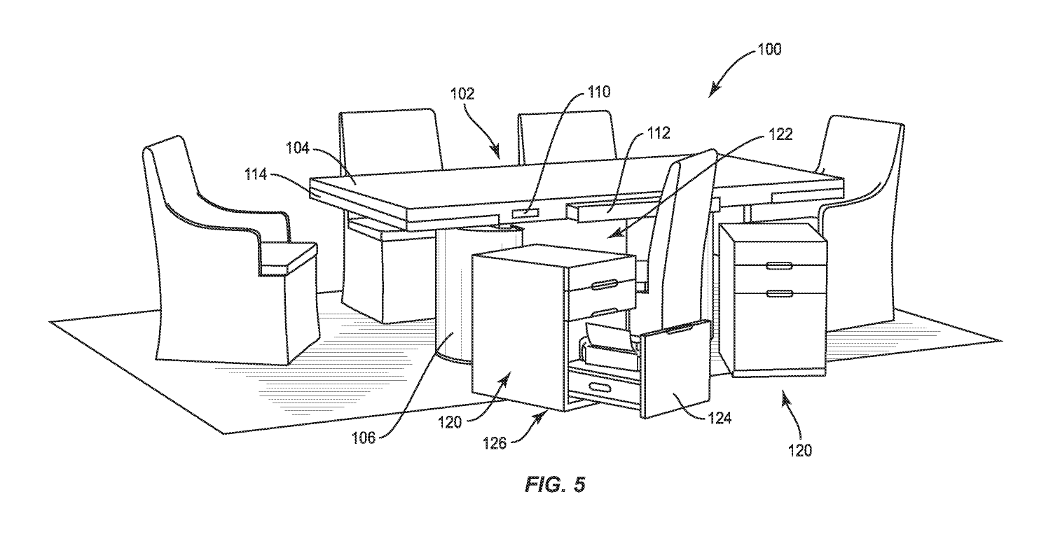

In some embodiments, the tabletop 102 includes one or more storage drawers 112. As seen in FIG. 1, the storage drawers 112 are centrally located along the major axis M of the tabletop 102, such as being bisected by the minor axis m. A storage drawer 112 is shown open in FIG. 5. The storage drawers 112 may be provided along one or both of the longer sides of the tabletop 102. In at least one embodiment, the storage drawer 112 is a pass-through drawer, where a single drawer can be accessed from both sides of the dining table 100.

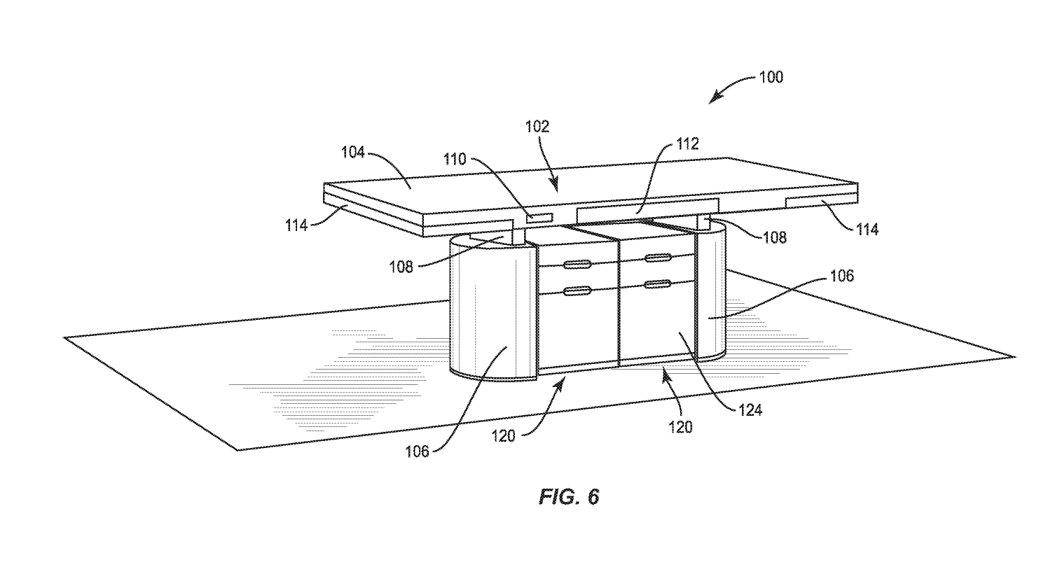

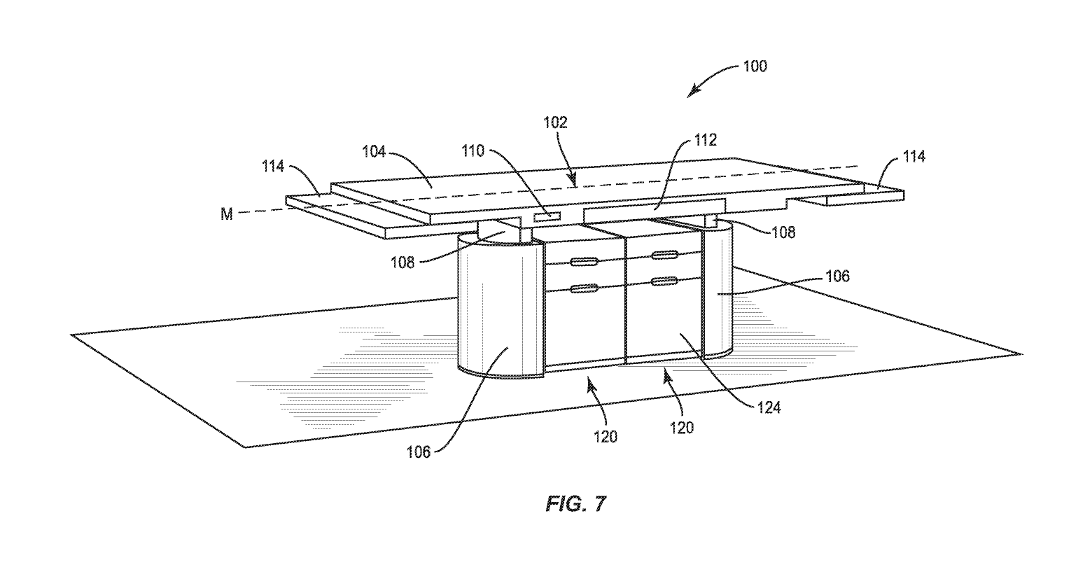

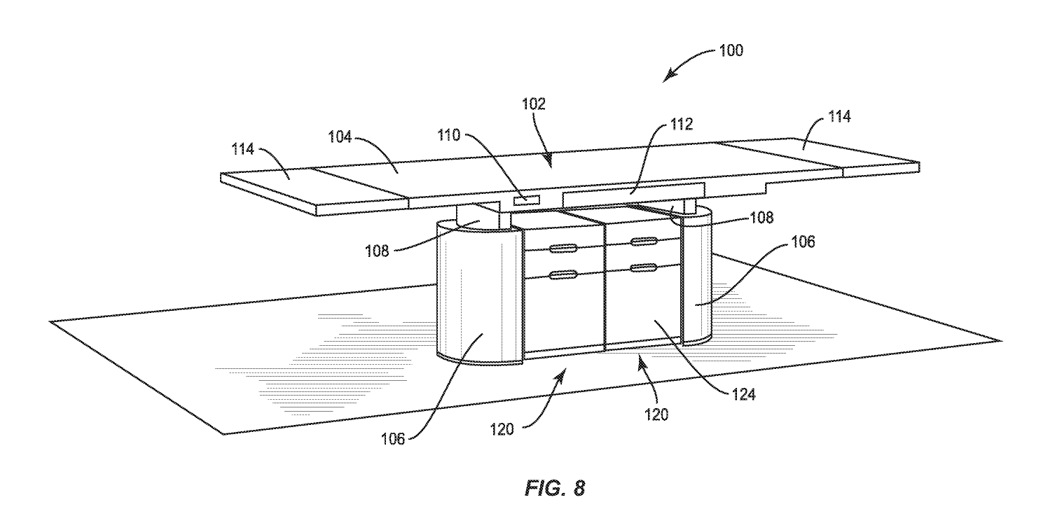

In at least one embodiment, the tabletop 102 is extensible from a non-extended position, shown in FIGS. 1 and 6, for example, to a fully extended position shown in FIG. 8. A pair of leaves 114 may be attached to and disposed below respective opposite ends of the tabletop 102 in the non-extended position. The leaves 114 are preferably integrated with the dining table 100 to remain connected to the table in both the extended and non-extended positions. As seen in the partially extended position of FIG. 7, each leaf 114 may slide outward in a direction substantially parallel with the major axis M and assume the extended position seen in FIG. 8 with the top surface of each leaf coplanar with the support surface 104 of the tabletop 102. Dining tables 100 with leaves 114 that extend from the ends are sometimes referred to as refectory tables. In some other embodiments, the leaves 114 are controlled by powered, electrical actuators as known in the art that can be activated from the control panel 110 used to adjust the height of the tabletop 102.

To further increase the functionality of the dining table 100 for purposes other than dining, at least one stowable storage cabinet 120 is positionable under the tabletop 102. Two such storage cabinets 120 are shown in the figures. The at least one storage cabinet 120 is configured to be stowed below the tabletop 102 and between the preferred pair of pedestals 106 such that the at least one storage cabinet substantially fills a gap 122 (FIG. 1A) between the pair of pedestals 106. Therefore, the tabletop 102 appears to be supported by a single central pedestal.

Each storage cabinet 120 can have at least one cabinet drawer 124. Each storage cabinet may include a plurality of casters 126 (FIG. 1) provided along the bottom to enhance portability. A retractable power cord (not shown) may be integrated into a side or bottom of the storage cabinet 120 such that the power cord plugs into or is hardwired to a respective pedestal 106. The pedestal 106 may be configured to receive power from a power source within the floor to provide the necessary power for operation of the telescoping portions 108. One or more sockets (not shown) may be provided within at least one of the cabinet drawers 124 of the storage cabinet 120 for powering any electronics stored within the storage cabinet, such as a printer or a paper shredder.

Although the above disclosure has been presented in the context of exemplary embodiments, it is to be understood that modifications and variations may be utilized without departing from the spirit and scope of the invention, as those skilled in the art will readily understand. Such modifications and variations are considered to be within the purview and scope of the appended claims and their equivalents.

1. A multi-function dining table, comprising:
a tabletop supported by a pair of pedestals, each pedestal significantly offset from a periphery of the tabletop, the tabletop being configured to be adjustable in a height direction relative to a floor such that the tabletop can be positioned at a sitting height, a counter height, and a standing height;
at least one storage cabinet comprising at least one drawer and a plurality of casters,
wherein the tabletop comprises at least one leaf capable of extending a support surface of the tabletop, and
wherein the tabletop comprises integrated controls to actuate at least the height adjustment of the tabletop,
wherein a cavity is defined between the pair of pedestals, the cavity having a width and a depth, and the at least one storage cabinet is sized and dimensioned to fit closely within the width and the depth of the cavity such that the tabletop appears to be supported by a single central pedestal at least when positioned at the sitting height,
wherein the at least one leaf folds and unfolds when actuated by the integrated controls,
wherein the tabletop comprises at least one drawer, the at least one drawer raising and lowering with the tabletop.

2. The multi-function dining table according to claim 1, wherein the at least one leaf comprises a pair of leaves, each leaf disposed below respective opposite ends of the tabletop in a non-extended position.

3-15. (canceled)
